(19) United States
(12) Patent Application Publication
(10) Pub. No.: US 2009/0090008 A1
(43) Pub. Date: Apr. 9, 2009

(54) Cutter

(76) Inventor: Tooru Nagasoe, Fukuoka (JP)

Correspondence Address: WENDEROTH, LIND & PONACK, L.L.P., 2033 K STREET N. W., SUITE 800, WASHINGTON, DC, 20006-1021, US

(21) Appl. No.: 12/230,918

(22) Filed: Sep. 8, 2008

(30) Foreign Application Priority Data
Oct. 9, 2007 (JP) JP2007-263292

(51) Int. Cl. B23D 21/08; B26D 3/16

(52) U.S. Cl. 30/101

(57) ABSTRACT

A cutter is capable of cutting a pipe-shaped object so as to produce a cut surface which is almost perfectly perpendicular to a longitudinal direction of the pipe-shaped object. A blade has a disc-shaped base plate having a blade edge on an outer periphery of the base plate, a level surface perpendicular to an axis of rotation of the base plate, and a sloped surface opposite the level surface and inclined with respect to the level surface so that a thickness of the blade increases toward a central portion of the blade. The sloped surface is shaped such that an angle of inclination of an outer peripheral portion of the sloped surface with respect to the level surface is larger than an angle of inclination of a remaining portion of the sloped surface with respect to the level surface. The level surface has fine grooves thereon. As long as the grooves are formed at intervals from the outer periphery to the center of the blade, the grooves may constitute either a spiral formed all over the level surface 5 or concentric circles.

### BACKGROUND OF THE INVENTION

1. Field of the Invention

The present invention relates to a cutter used for cutting pipes or the like.

2. Description of the Related Art

FIGS. 5A and 5B show a structure of a blade for a cutter which has been conventionally used for cutting a pipe-shaped object.

In a blade 51 shown in FIG. 5A, a mounting hole 53 is provided at a center of a disc-shaped base plate 52. An outer periphery of the base plate 52 is sharpened to function as a blade edge 54. When viewing the blade 51 from the side, as shown in FIG. 5B, sloped surfaces 55 are formed on both sides of the blade edge 54 with the blade edge 54 as the axis of symmetry so that the thickness of a central portion of the base plate 52 is larger than the thickness of a peripheral portion of the base plate 52. In other words, in the conventional blade 51, the thickness of the blade 51 increases on both sides of the blade edge 54 in a similar manner so that the thickness increases toward the center of the blade 51 from the blade edge 54 formed on the outer periphery.

When a pipe-shaped object is cut with the above conventional blade, a cut surface 57 of an object 56 is slanted as shown in FIG. 5C and cannot have a section perpendicular to the longitudinal direction of the pipe-shaped object. If the pipes having the slanted cut surfaces are connected to each other, a gap is generated between the connected surfaces. Moreover, this blade also causes burrs during the cutting process, which requires extra work for removing the burrs.

Pipe-shaped objects are being used in a variety of fields. In particular, when used in an apparatus like an air conditioner where a gas such as a refrigerant flows through a pipe, if a gas leaks from a connection between pipes or a connected portion of a pipe with a flare which opens like a bugle, the natural environment is damaged. In order to prevent a gas from leaking from the connection, the pipe must be cut in such a manner that the cut surface thereof has a cut surface which is almost perfectly perpendicular to the longitudinal direction of the pipe.

Japanese Unexamined Utility Model Publication No. 60-162923 discloses a blade having an asymmetrical blade edge with one side being flat and the other side sloped. In Japanese Unexamined Utility Model Publication No. 60-162923, however, nothing has been suggested with regard to obtaining a cut surface which is perpendicular to a longitudinal direction of an object to be cut, and it is regarded that the shape of the blade illustrated in the drawings of this publication is not intended to this purpose. In addition, with the blade shown in the publication, since the portion that touches an object to be cut is sharp, the position where the blade touches an object to be cut is unstable during a cutting operation, leading to failure in proper cutting only with a spiral trace left on the object.

In view of the above problems, an object of the present invention is to provide a cutter for cutting a pipe-shaped object which is capable of cutting the pipe-shaped object so as to produce a cut surface which is almost perfectly perpendicular to the longitudinal direction of the pipe-shaped object.

### SUMMARY OF THE INVENTION

In order to solve the above problems, a cutter according to the present invention is a cutter comprising a shaft, a bearing, and a blade which is mounted on one end of the shaft to face the bearing and rotates to cut an object placed between the blade and the bearing, the blade comprising a disc-shaped base plate having a blade edge on an outer periphery of the base plate, a level surface perpendicular to an axis of rotation of the base plate, the level surface having a spiral groove or concentric grooves formed on the level surface, and a sloped surface opposite the level surface and inclined with respect to the level surface so that a thickness of the blade increases toward a central portion of the blade, wherein the sloped surface is shaped such that an angle of inclination of an outer peripheral portion of the sloped surface with respect to the level surface is larger than an angle of inclination of a remaining portion of the sloped surface with respect to the level surface.

Since the blade has a level surface perpendicular to an axis of rotation of the base plate and a sloped surface opposite the level surface and inclined with respect to the level surface so that a thickness of the blade increases toward a central portion of the blade, the level surface functions as a cutting face when cutting an object while the sloped surface functions as a supporting face to support the object, thereby obtaining a cut surface which is perpendicular to the longitudinal direction of the object.

Furthermore, since an angle of inclination of an outer peripheral portion of the sloped surface with respect to the level surface is larger than an angle of inclination of a remaining portion of the sloped surface with respect to the level surface, the blade can touch an object to be cut in a more stable manner compared to a sharp blade edge, leading to excellent cutting.

With a spiral groove or concentric grooves formed on the level surface, these grooves add appropriate resistance during a cutting process and prevent the abrupt progress of the cutting. The blade of the present invention having an asymmetrical form may apt to be unstable when touching an object to be cut. However, due to the existence of the grooves formed on the level surface, cutting progresses gradually so that a fulcrum slowly moves on the slopes surface, which provides stability when the blade touches the object.

According to the present invention, preferably, the shaft may be divided in a longitudinal direction of the shaft into a first shaft positioned on a side close to the blade and a second shaft positioned on a side far from the blade, the first and the second shafts being connected to each other via a connecting rod.

With the shaft being divided in the longitudinal direction of the shaft, wobbling of the shaft due to manufacturing errors or the like can be reduced. Moreover, if the first and the second shafts wobble, the connecting rod which connects these shafts can correct the wobbling.

According to the present invention, preferably, the cutter may further comprise means for pushing the connecting rod in toward the blade depending on a cutting depth of the blade and fixing the connecting rod.

By pushing the connecting rod in toward the blade in to the degree corresponding to the cutting depth and fixing the rod in advance, it is not necessary to push the blade forward with the progress of a cutting operation. Additionally, the blade is maintained to cut into an object firmly during the cutting operation, which prevents positioning of the blade from moving away from the object. Therefore, the blade can touch the object in a stable manner.

The means for pushing the connecting rod in toward the blade and fixing the connecting rod may be so constructed that, when the connecting rod is pushed in toward the blade, an end of the connecting rod touches a concave portion formed inside a main body part of the first shaft and is fixed in a state where a spring wound around a part of the connecting rod is being compressed.

By the above structure, when cutting is started, the connecting rod is pushed in toward the blade with the spring being compressed and, with progress of the cutting operation, the blade is pushed forward to an object to be cut by a restoring force of the compressed spring. Thus, the blade constantly touches an object to be cut with an appropriate pressure, providing stability when the blade touches the object.

According to the present invention, preferably, the end of the connecting rod which touches the concave portion may be formed to have an acute angle, and the concave portion may have a shape which fits a shape of the end of the connecting rod.

The end of the connecting rod formed as above can be better prevented from wobbling when touching the concave portion in comparison with an end of the connecting rod formed in a flat shape, which also contributes to stability of the blade when touching an object to be cut.

According to the present invention, a plurality of connecting rods may be provided to connect the first shaft and the second shaft.

By connecting the first and the second shafts with the plurality of connecting rods, connection by the connecting rod that is positioned at the center of the plurality of connecting rods is supported by other connecting rods positioned around the rod at the center. Therefore, the connected portion is unlikely to twist.

By the present invention, it is possible to realize a cutter which is capable of cutting a pipe-shaped object so as to produce a cut surface which is almost perfectly perpendicular to the longitudinal direction of the pipe-shaped object.

### BRIEF DESCRIPTION OF THE DRAWINGS

In the accompanying drawings:

FIGS. 1A to 1F illustrate a structure of a blade for a cutter of an embodiment of the present invention;

FIG. 2 illustrates a structure of a cutter of the embodiment of the present invention;

FIGS. 3A to 3D illustrate a structure of a shaft of the cutter of the embodiment of the present invention in detail;

FIGS. 4A to 4C illustrate an example where a plurality of connecting rods are provided in the cutter of the embodiment of the present invention; and

FIGS. 5A to 5C illustrate a structure of a blade for a cutter which has been conventionally used for cutting a pipe-shaped object.

### DETAILED DESCRIPTION OF THE PREFERRED EMBODIMENT

With reference to the accompanied drawings, embodiments of the present invention will be explained below.

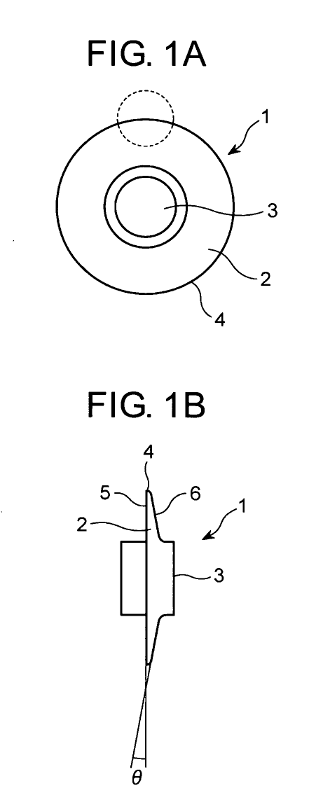

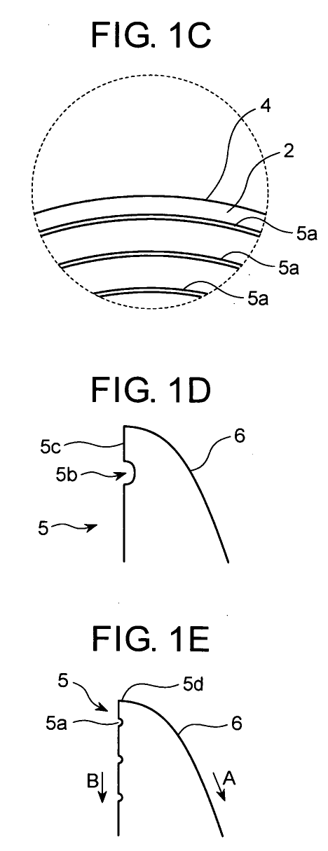

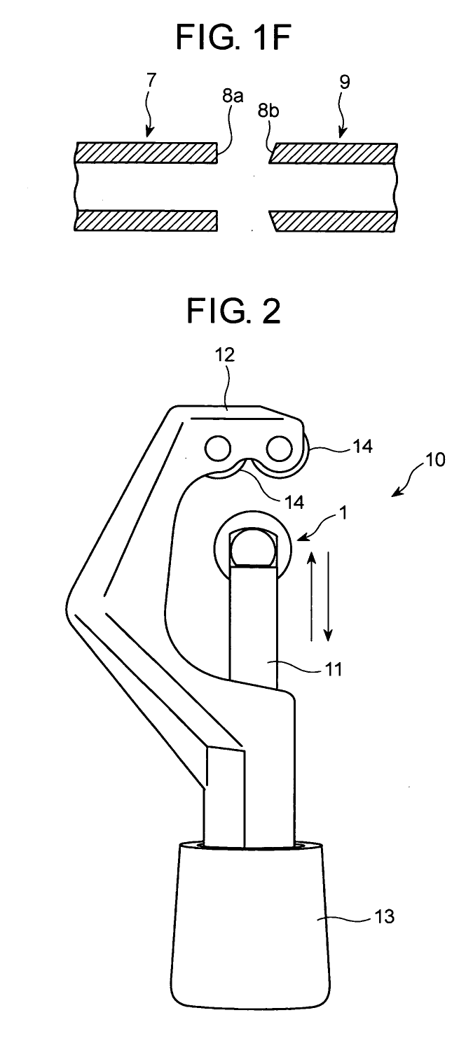

A structure of a blade for a cutter of an embodiment of the present invention is illustrated in FIGS. 1A to 1F. FIG. 1A is a front view of the blade, and FIG. 1B is a side view of the blade of FIG. 1A.

In FIG. 1A, a blade 1 has a disc-shaped base plate 2 with a mounting hole 3 provided at a center of the base plate 2. An outer periphery of the base plate 2 functions as a blade edge 4. On the mounting hole 3, a bearing may be provided for smooth rotation of the base plate 2.

When the blade 1 is viewed from a side, as shown in FIG. 1B, one side of the blade 1 forms a level surface 5 as a whole while the other side of the blade 1 forms a sloped surface 6 which is inclined with respect to the level surface 5 so that a thickness of the blade 1 increases toward a central portion of the blade 1. The sloped surface 6 is shaped such that an angle of inclination of an outer peripheral portion of the sloped surface 6 with respect to the level surface 5 is larger than an angle of inclination of a remaining portion of the sloped surface 6 with respect to the level surface 5. In other words, the angle of inclination of a central area of the sloped surface 6 with respect to the level surface 5 is θ as shown in FIG. 1B whereas the angle of inclination of the sloped surface 6 with respect to the level surface 5 continuously increases toward an outer periphery of the blade 1.

As described above, the blade 1 of the cutter according to the present invention has the sloped surface 6 only on one side of the blade edge 4. Thus, besides the asymmetrical configuration of the blade 1 when viewed from the side, it is a noticeable characteristic that the angles of inclination of the sloped surface 6 are different between the area close to the outer periphery and the area close to the center of the blade 1.

FIG. 1C illustrates the level surface S of the blade 1 in detail. On the level surface 5, fine grooves 5a are formed. As long as the grooves 5a are formed at intervals from the outer periphery to the center of the blade 1, the grooves 5a may constitute either a spiral formed all over the level surface 5 or concentric circles.

FIG. 1D illustrates another configuration of the blade 1, in which a cut-out portion 5b is formed on a part of the level surface 5 of the blade 1. On a side close to the outer periphery of the blade 1, a flat portion 5c is formed depending on a cutting depth of the blade 1, and the cut-out portion 5b is provided adjacent to the flat portion 5c on a side close to the center of the blade 1. In this case, the grooves 5a which are formed only on the flat portion 5c can work sufficiently.

FIG. 1E illustrates an end portion of the blade 1 on the side close to the outer periphery. Based on this drawing, a cutting mechanism using the blade 1 is explained below referring to a case of cutting a pipe as an example.

A pipe, which is an object to be cut, touches an end 5d on the side close to the outer periphery of the blade 1. The blade 1 rotates around the pipe and, at the same time, the end 5d on the side close to the outer periphery of the blade 1 cuts into the pipe, thereby advancing cutting. Specifically, at an initial stage of cutting, the end 5d on the side close to the outer periphery of the blade 1 functions as a fulcrum for cutting the pipe. In both sides constituting the blade 1, the level surface 5 functions as a cutting face which cuts the pipe whereas the sloped surface 6 functions as a supporting face which supports the pipe. As the cutting operation progresses, the fulcrum moves in a direction of an arrow A on the sloped surface 6. In order for the movement of the fulcrum to go on smoothly, it is preferable that the sloped surface 6 be formed of a smooth face. On the other hand, since the level surface 5 has the fine grooves 5a thereon, the grooves 5a add appropriate resistance during the cutting process and prevent the abrupt progress of the cutting in a direction of an arrow B. The blade 1 of the present invention having an asymmetrical form may apt to be unstable when touching an object to be cut. However, due to the existence of the grooves 5a, cutting progresses gradually so that the fulcrum slowly moves on the sloped surface 6. Therefore, the blade 1 can firmly hold the object to be cut and provide stability when touching the object.

FIG. 1F shows a sectional view when a pipe-shaped object is cut with the blade 1. In FIG. 1F, as the pipe-shaped object is cut so that the level surface 5 of the blade 1 faces a side of a cut object 7 of the pipe-shaped object which is to be used after cutting, a cut surface 8a forms a level surface. In this case, as the sloped surface 6 of the blade 1 faces a side of a cut object 9 of the pipe-shaped object which is to be disposed of after cutting, a cut surface 8b forms a sloped surface. In other words, with the blade 1 of the present invention, which has the asymmetrical form, only the cut surface 8a that is to be used after cutting can be the level surface, which realizes expedient cutting.

An angle of inclination θ of the sloped surface 6 shown in the drawings is 7 degrees or more. Furthermore, in order to maintain this angle of inclination even after a long-term use, preferably, the blade 1 may be made of a metal having a Rockwell hardness in a range from 62 to 64. It is further preferable that the metal has relatively high toughness.

Next, a cutter employing the above-described blade is explained below.

FIG. 2 illustrates a structure of a cutter according to the embodiment of the present invention.

In a cutter 10 shown in FIG. 2, the blade 1 is mounted on a side of one end of a shaft 11. The other end of the shaft 11 is held inside a handle 13 via an arm 12. As the handle 13 rotates, the shaft 11 is movable in a direction shown by arrows. Two bearings 14 are provided in the arm 12 so as to face the blade 1. Between the blade 1 and the bearings 14, a pipe-shaped object to be cut is put with its longitudinal direction being perpendicular to the drawing sheet. Then, the cutter 10 is rotated while holding the object between the blade 1 and the bearings 14 facing each other, thereby cutting the object.

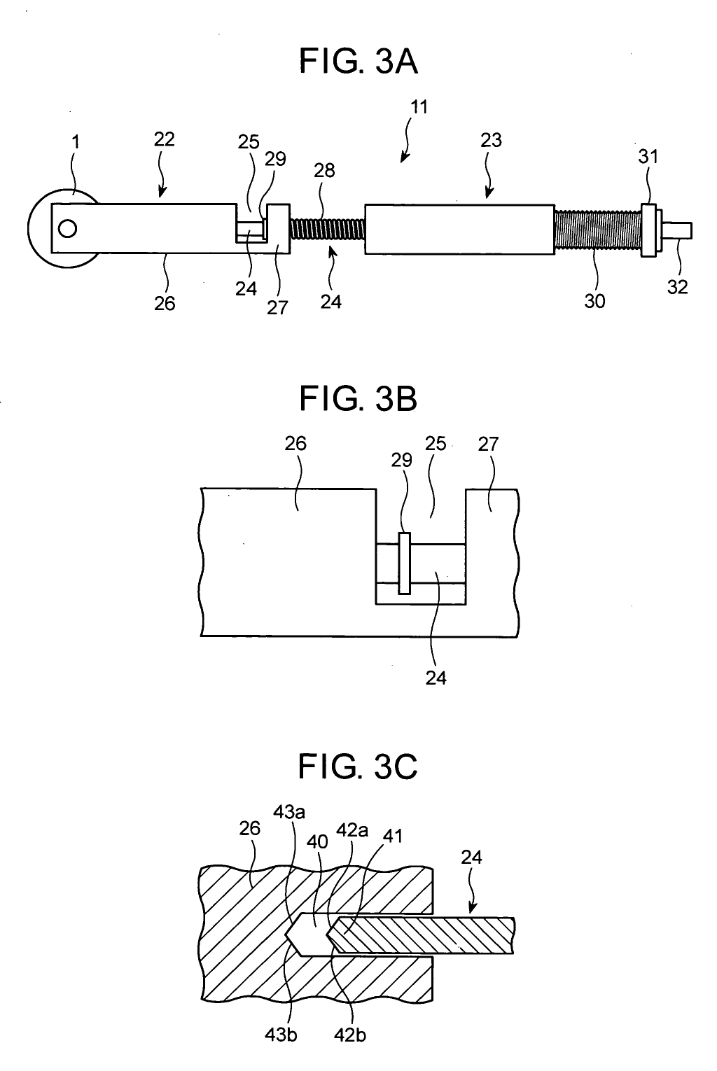

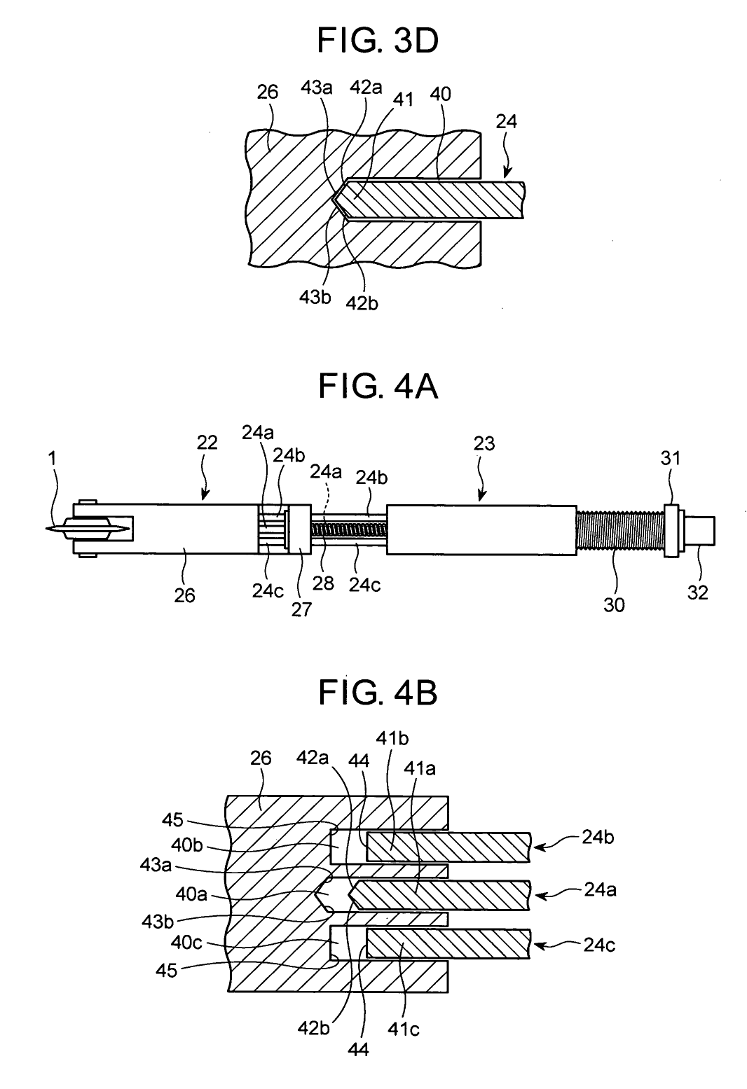

FIG. 3A illustrates the shaft 11 in detail. The shaft 11 is divided, in a longitudinal direction, into a first shaft 22 which is positioned on a side close to the blade 1 and a second shaft 23 which is positioned on a side far from the blade 1. The first shaft 22 and the second shaft 23 are connected to each other via a connecting rod 24. The first shaft 22 has a cut-out portion 25. In the first shaft 22, provided are a main body part 26, the cut-out portion 25, and a projecting part 27 in this order from the side close to the blade 1. One end of the connecting rod 24 is fixed inside the second shaft 23, and the other end of the connecting rod 24 passes through the projecting part 27 of the first shaft 22 and is supported inside the main body part 26. The detailed structure of supporting the end of the connecting rod 24 inside the main body part 26 is explained later.

A spring 28 is wound around a part of the connecting rod 24 on an area between the first shaft 22 and the second shaft 23. On a part of the connecting rod 24 which is brought into contact with the projecting part 27, a stopper 29 made of a circular plate is mounted. On a side opposite the blade 1, a thread part 30, an expanding part 31 and an end portion 32 are formed in this order adjacent to the second shaft 23. The thread part 30, the expanding part 31 and the end portion 32 are held inside the handle 13 shown in FIG. 2. The thread part 30 is screwed into a thread formed on an inner side of the handle 13.

By rotating the handle 13, the second shaft 23 is made closer to the side of the blade 1 via screwing with the thread part 30, and the connecting rod 24 is pushed in toward the blade 1. Then, the connecting rod 24 moves forward to the blade 1 to compress the spring 28. The first shaft 22 at this stage is illustrated in FIG. 3B in detail. As the connecting rod 24 advances, the stopper 29 separates from the projecting part 27.

An action of the end of the connection rod 24 inside the main body part 26 of the first shaft 22 before and after pushing in the connecting rod 24 toward the blade 1 is illustrated in FIGS. 3C and 3D.

FIG. 3C shows a state before the connecting rod 24 is pushed in toward the blade 1 where an end 41 of the connecting rod 24 is in a position separate from a concave portion 40 formed inside the main body part 26. By pushing in the connecting rod 24 toward the blade 1, as shown in FIG. 3D, faces 42a and 42b of the end 41 of the connecting rod 24 are brought into contact with faces 43a and 43b of the concave portion 40 inside the main body part 26, respectively, and stop. In this manner, the state in which the shaft 11 is being pushed in toward the blade is fixed by the handle 13.

For precise positioning of the end 41 of the connecting rod 24 against the concave portion 40, it is preferable that an angle of the face 42a of the end 41 with respect to the face 42b of the end 41 be an acute angle of approximately 60 degrees and that the concave portion 40 is formed to have a shape that fits a shape of the end 41. With the end 41 formed in this configuration, it is possible to prevent wobbling of the end 41 in the concave portion 40 when the end 41 contacts the concave portion 40 in comparison with a structure in which the end 41 has a flat shape. This contributes to stability of the blade 1 when touching an object to be cut.

According to the method describe above, the handle 13 is rotated to push in the connecting rod 24 toward the blade 1 to the degree corresponding to cutting depth and fixed. Thus, it is not necessary to push the blade forward as a cutting operation progresses. Besides, since the blade is maintained to firmly cut in an object to be cut during the cutting operation, the blade does not wobble on the object. Furthermore, as the shaft 11 is divided into the first shaft 22 and the second shaft 23, each of the first shaft 22 and the second shaft 23 can be formed to have a smaller length. Accordingly, compared to a case where the shaft 11 is made of a single member, wobbling of the shaft 11 due to manufacturing errors or the like can be reduced. Moreover, if the first shaft 22 and the second shaft 23 wobble, the connecting rod 24 can correct the wobbling.

At an initial stage of cutting, as the connecting rod 24 is pushed in toward the blade 1 with the spring 28 being compressed, the blade 1 is in the closest position to the second shaft 23. While cutting progresses, the blade 1 advances toward the object to be cut by a restoring force of the compresses spring 28, and the connecting rod 24 moves away from the blade 1. Eventually, the stopper 29 abuts one side of the projecting portion 27 and stops, that is, the shaft 11 reverts to a state before starting the cutting operation.

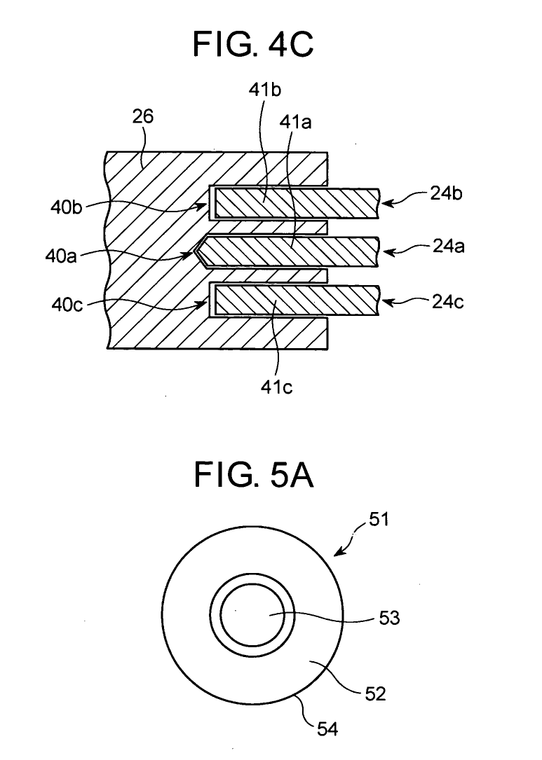

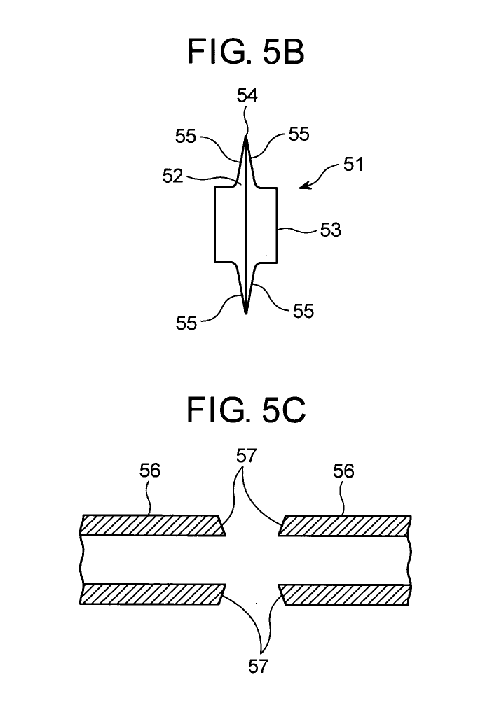

FIGS. 4A to 4C illustrate an example having a plurality of connecting rods. FIG. 4A shows an example with connecting rods 24a, 24b and 24c provided on the shaft 11 of FIG. 3A as a view taken from an upper side of the drawing sheet. The basic structure of the shaft shown in FIG. 4A is similar to the one in FIG. 3A except that, for connecting the first shaft 22 and the second shaft 23, the two connecting rods 24b and 24c are provided around the connecting rod 24a which is positioned at a center. The spring 28 is wound around the connecting rod 24a on an area between the first shaft 22 and the second shaft 23. Although the spring 28 may be wound around the connecting rods 24b and 24c as well, it is sufficient to wind the spring 28 at least around the connecting rod 24a which is positioned at the center, as illustrated in FIG. 4A.

FIG. 4B shows positions of the connecting rods 24a, 24b and 24c before the connecting rods 24a, 24b and 24c are pushed in toward the blade 1. In this figure, ends 41a, 41b and 41c of the connecting rods 24a, 24b and 24c are separate from concave portions 40a, 40b and 40c formed inside the main body part 26. FIG. 4C shows a state after the connecting rods 24a, 24b and 24c are pushed in toward the blade 1, in which the ends 41a, 41b and 41c of the connecting rods 24a, 24b and 24c are inserted into the concave portions 40a, 40b and 40c inside the main body part 26 and stop.

When the connecting rods 24a, 24b and 24c are pushed in toward the blade 1, the faces 42a and 42b on the end 41a of the connecting rod 24a positioned at the center are brought into contact with the faces 43a and 43b of the concave portion 40a inside the main body part 26, respectively. Here, lengths of the connecting rods 24b and 24c around the connecting rod 24a are adjusted so that faces 44 of the ends 41b and 41c of the connecting rods 24b and 24c do not touch faces 45 of the concave portions 40b and 40c inside the main body part 26. The faces 44 and 45 are formed to be flat.

By this structure, the faces 42a and 42b of the end 41a of the connecting rod 24a positioned at the center are brought into contact with the faces 43a and 43b of the concave portion 40a inside the main body part 26, respectively, thereby stopping the connecting rod 24a. At the same time, the connecting rods 24b and 24c positioned around the connecting rod 24a act to support connection by the connecting rod 24a positioned at the center. Therefore, a twist of the connecting portion can be prevented, leading to stable support of the blade 1.

The present invention can be used as a cutter capable of cutting a pipe-shaped object to produce a section which is almost perfectly perpendicular to the longitudinal direction of the object. In particular, the present invention is useful when cutting a pipe made of relatively soft material such as copper. The cutter can also be applied to a use such as cutting a pipe for plumbing an air conditioner.

Although the invention has been described in its preferred form with a certain degree of particularity, it is understood that the present disclosure of the preferred form has been changed in the details of construction and the combination and arrangement of parts may be resorted to without departing from the spirit and the scope of the invention as hereinafter claimed.

1. A cutter comprising:
a shaft;
a bearing; and
a blade which is mounted on one end of the shaft to face the bearing and rotates to cut an object placed between the blade and the bearing, the blade comprising:
a disc-shaped base plate having a blade edge on an outer periphery of the base plate;
a level surface perpendicular to an axis of rotation of the base plate, the level surface having a spiral groove or concentric grooves formed on the level surface; and
a sloped surface opposite the level surface and inclined with respect to the level surface so that a thickness of the blade increases toward a central portion of the blade, wherein the sloped surface is shaped such that an angle of inclination of an outer peripheral portion of the sloped surface with respect to the level surface is larger than an angle of inclination of a remaining portion of the sloped surface with respect to the level surface.

2. The cutter of claim 1, wherein the shaft is divided in a longitudinal direction of the shaft into a first shaft positioned on a side close to the blade and a second shaft positioned on a side far from the blade, the first and the second shafts being connected to each other via a connecting rod.

3. The cutter of claim 2, further comprising means for pushing in the connecting rod toward the blade depending on a cutting depth of the blade and fixing the connecting rod.

4. The cutter of claim 3, wherein the means for pushing in the connecting rod toward the blade and fixing the connecting rod is so constructed that, when the connecting rod is pushed in toward the blade, an end of the connecting rod touches a concave portion formed inside a main body part of the first shaft and is fixed in a state where a spring wound around a part of the connecting rod is being compressed.

5. The cutter of claim 4, wherein the end of the connecting rod which touches the concave portion is formed to have an acute angle, and the concave portion has a shape which fits a shape of the end of the connecting rod.

6. The cutter of claim 2, wherein a plurality of connecting rods are provided to connect the first shaft and the second shaft.

7. The cutter of claim 3, wherein a plurality of connecting rods are provided to connect the first shaft and the second shaft.

8. The cutter of claim 4, wherein a plurality of connecting rods are provided to connect the first shaft and the second shaft.

9. The cutter of claim 5, wherein a plurality of connecting rods are provided to connect the first shaft and the second shaft.
